(19) United States
(12) Patent Application Publication
(10) Pub. No.: US 2021/0138487 A1
(43) Pub. Date: May 13, 2021

(54) Fluidic Component

(71) Applicant: FDX Fluid Dynamix GmbH, Berlin (DE)

(72) Inventors: Bernhard Bobusch, Berlin (DE); Oliver Krüger, Berlin (DE); Jens Hermann Wintering, Berlin (DE)

(21) Appl. No.: 16/634,549

(22) PCT Filed: Jul. 20, 2018
(86) PCT No.: PCT/EP2018/069785

§ 371 Date: Jan. 27, 2020

(30) Foreign Application Priority Data
Jul. 25, 2017 (DE) 10 2017 212 747.3

(51) Int. Cl. B05B 1/08; B05B 1/12

(52) U.S. Cl. CPC B05B 1/08; B05B 1/12

(57) ABSTRACT

Provided is a fluidic component have a flow chamber, which flow chamber can be flowed through by a fluid flow, which enters into the flow chamber through an inlet opening of the flow chamber and passes out of the flow chamber through an outlet opening of the flow chamber. At least one device is provided for creating an oscillation of the fluid flow at the outlet opening. The device has a changeable shape.

The invention relates to a fluidic component as per the preamble of claim 1 and to a fluid-distributing appliance which comprises a fluidic component of said type.

In fluid-distributing appliances, such as for example cleaning appliances, it is desirable to be able to generate fluid jets with different spray characteristics in order to satisfy the requirements in different fields of use. For example, there is a demand for an appliance which can selectively generate round and fan-shaped jets. It is thus possible for very stubborn dirt to be treated and cleaned in punctiform fashion with the high jet impetus of a round jet, and for sensitive surfaces to be treated and cleaned areally with the locally lower jet impetus of a fan-shaped jet (that is to say with lower output per unit of area). A fan-shaped jet or a fluid jet with a large spatial distribution of the fluid is highly suitable for rinsing purposes.

To generate a fluid jet with different spray characteristics, nozzle systems are known from the prior art in which switching back and forth between a multiplicity of nozzles, each with different spray characteristics, is realized for example by means of a slide or a rotary mechanism. Here, each nozzle has a defined and invariant spray characteristic, and fixedly predefines a jet shape for the fluid jet.

These nozzle systems generate quasistatic or static and non-oscillating fluid jets. To generate a moving fluid jet, nozzles are known from the prior art which are set in motion by means of a kinematic mechanism or a (movable) device. The kinematic mechanism or (movable) device comprises movable components which are subject to high levels of wear. The costs associated with production and maintenance are correspondingly high. Furthermore, owing to the movable components, a relatively large structural space is required overall.

To generate a movable fluid flow (or fluid jet), fluidic components are also known which generate a fluid jet which oscillates in a plane. The fluidic components comprise no movable components that serve for generating a movable fluid flow. In this way, by contrast to the nozzles with movable components, they do not have the disadvantages that result from the movable components.

The fluidic component is provided for generating a moving, oscillating or pulsing fluid jet. Examples of fluid flow patterns of an oscillating jet are sinusoidal jet oscillations, rectangular, sawtooth-shaped or triangular jet profiles, spatial or temporal jet pulsations and switching processes. Such fluid jets are used for example in order to distribute a fluid jet (or fluid flow) uniformly on a target area. The fluid flow may be a liquid flow, a gas flow, a multi-phase flow (for example wet steam) or else a fluid containing particles.

The fluidic components known from the prior art for generating a moving fluid flow generally have a fixed spray characteristic in the case of a constant volume flow and/or entry pressure of the fluid. U.S. Pat. No. 6,497,375 B1 and WO 02/07893 A1 describe fluidic components with different operating points, in the case of which, by means of closable air ingress bores, air can be conducted into the fluidic components and the oscillation can be activated and deactivated in targeted fashion. It is thus possible to switch between a spray jet with a fixed oscillation angle and a punctiform spray jet. US 2006/0065765 A1 has disclosed a device which comprises a multiplicity of fluidic components which have respectively different spray characteristics and of which selectively one fluidic component can be rotated into the fluid jet and a fluid flow with different spray characteristics can thus be generated (in a manner dependent on the selection of the fluidic component). Such a device requires a relatively large structural space overall. Furthermore, the spray characteristic of the emerging fluid flow can be varied only between a predefined number of possibilities.

The present invention is based on the object of creating a device which is designed to generate a moving fluid jet, the spray characteristic of which is settable prior to operation and/or variable during operation, wherein the device exhibits a high degree of fail safety and involves correspondingly low maintenance effort.

Said object is achieved according to the invention by means of a fluidic component having the features of claim 1. The subclaims specify embodiments of the invention.

Accordingly, the fluidic component comprises a flow chamber, which flow chamber can be flowed through by a fluid flow which enters the flow chamber through an inlet opening of the flow chamber and which exits the flow chamber through an outlet opening of the flow chamber. Preferably, the inlet opening and the outlet opening are arranged on mutually opposite sides of the flow chamber. In the flow chamber, there is provided at least one means for generating an oscillation of the fluid flow at the outlet opening. The means for generating an oscillation may for example be at least one secondary flow channel. Other means for generating an oscillation of the fluid flow may alternatively also be provided.

The fluidic component is characterized in that the flow chamber has a variable shape. For the variation of the shape of the flow chamber, it is possible in particular for a device to be provided which acts in targeted fashion on the fluidic component and thus effects a change in the shape of the flow chamber. The change in shape of the flow chamber is in this case preferably reversible. This means that the device can effect and also reverse a change in shape. For the variation of the shape of the flow chamber, various parameters of the fluidic component (or parts thereof), such as for example the shape or the volume, may be varied. In this way, a variation of the spray characteristic of the emerging fluid flow can be effected without varying the parameters of the fluid flowing through the fluidic component, such as for example the type of fluid, the entry pressure of the fluid, the entry speed of the fluid and the volume throughflow. The variation of the shape may be performed in continuously variable fashion (or optionally also in stepped fashion), such that the spray characteristic of the emerging fluid flow correspondingly also changes in continuously variable fashion (in stepped fashion) and can thus be adapted in targeted fashion to a specific application. The spray characteristic may in particular relate to the spray angle that can be set by means of the fluidic component according to the invention. Accordingly, the emerging fluid jet can be modulated between a punctiform jet and a fan-shaped jet. The fluidic component according to the invention can be used for generating a directed fluid jet with an adjustable spray characteristic for the targeted wetting, sprinkling or coating of a surface. Since, by means of the fluidic component according to the invention, the emerging fluid flow firstly performs an oscillation movement and, secondly, can be adjusted in terms of its spray characteristics, the cleaning, the surface wetting or the surface treatment performance can be massively increased. Since no movable components are used to generate the oscillation, the likelihood of failure can also be reduced. By changing the spray characteristic of the emerging fluid flow, the fluidic component can be adapted to different cleaning requirements. Thus, the fluidic component according to the invention is of interest for high-pressure, medium-pressure and low-pressure cleaning and for surface treatment and for surface coating. The variation of the shape of the flow chamber may be performed prior to commencement of operation or also during the operation of the fluidic component, that is to say while a fluid is flowing through the fluidic component.

The fluid that enters the flow chamber through the inlet opening may be charged with a pressure of 0.001 to 6000 bar (in relation to the ambient pressure). The pressure may preferably lie between 0.005 and 1800 bar. A pressure range between 0.05 and 1100 bar is especially preferred. For some applications, so-called low-pressure applications, such as for example for washing machines, dishwashers and fluid-distributing devices (sprinkler devices, handheld showers or cleaning installations), an entry pressure of 0.01 bar to 12 bar above ambient pressure is advantageous. For medium-pressure applications, such as for example high-pressure cleaning appliances with low power output, or kitchen appliances with integrated cleaning appliances, the entry pressure preferably lies between 6 bar and 120 bar above ambient pressure. In the case of high-pressure applications, the entry pressure may amount to over 40 bar. The oscillation frequency of the oscillating fluid flow emerging from the fluidic component may lie between 0.25 Hz and 40 kHz. A preferred frequency range lies between 3 Hz and 600 Hz.

The fluid may be a gaseous, liquid or multi-phase flowable medium, which may also contain particles. If the fluid is a liquid (for example water), it is advantageous for the geometry of the fluidic component to be selected such that, within the fluidic component (upstream of the outlet opening), a pressure dissipation occurs which is smaller than the pressure dissipation that occurs at the outlet opening. The geometrical parameters (shape, size, number and shape of the secondary flow channels, (relative) size of the inlet and outlet opening) of the fluidic component are in this case selected such that the pressure with which the fluid flow is charged when it enters the fluidic component via the inlet opening is substantially dissipated at the outlet opening. If the fluid is water vapor, the parameters may be selected such that the pressure with which the fluid flow is charged when it enters the fluidic component via the inlet opening is dissipated already before (upstream of) the outlet opening.

In one embodiment, the flow chamber is delimited by a delimiting wall. Here, the delimiting wall need not form the external appearance of the fluidic component. The delimiting wall may be formed by the inner surface of a hollow body, wherein the cavity of the hollow body forms the flow chamber. The external appearance of the fluidic component is then defined by the outer surface of the hollow body. The outer surface of the hollow body may in particular be substantially cuboidal and have interruptions for the inlet opening and the outlet opening.

The flow chamber may have a main flow channel, which connects the inlet opening and the outlet opening to one another, and at least one secondary flow channel, as a means for generating an oscillation of the fluid flow at the outlet opening. The direction from the inlet opening to the outlet opening may in this case be regarded as the main flow direction of the fluid flow. Here, the main flow channel and the at least one secondary flow channel may be separated from one another by at least one inner block, such that the main flow channel, the at least one inner block and the at least one secondary flow channel are arranged substantially in a plane. The emerging fluid flow then oscillates in an oscillation plane which corresponds to the plane which is defined by the main flow channel, the at least one inner block and the at least one secondary flow channel. In particular, the flow chamber may have two secondary flow channels which lie in a plane with the main flow channel, wherein the main flow channel lies between the two secondary flow channels (as viewed transversely with respect to the main flow direction). In this case, each secondary flow channel is separated from the main flow channel by at least one inner block. The secondary flow channels may each have one entrance and one exit, via which said secondary flow channels are fluidically connected to the main flow channel.

In order to be able to vary the shape of the flow chamber, the delimiting wall may, in one embodiment, have at least one portion which is deformable. For this purpose, the at least one portion may have different material characteristics, such as for example material thickness or extensibility (elasticity), in relation to the rest of the delimiting wall. The at least one deformable portion of the delimiting wall can then be deformed under targeted action of an external force.

A targeted action of an external force is in particular not to be understood to mean the pressure of the fluid flowing through the fluidic component. Rather, a device for imparting the external force may be provided, which device is actuatable by a user. This likewise applies to the other embodiments.

As an alternative to the abovementioned targeted action of an external force, an internal force that results substantially from the pressure of the fluid flowing through the fluidic component may be utilized to deform the at least one deformable (for example elastic) portion of the delimiting wall in targeted fashion. Here, the at least one deformable portion may be designed such that it is reversibly deformable as a result of action of the internal force, that is to say changes from a first into a second configuration in the event of an increase of the mass flow at the inlet opening (of the entry pressure) and returns from the second into the first configuration in the event of a drop of the mass flow at the inlet opening (of the entry pressure). The transition between more than two configurations, or a continuously variable transition, is also conceivable. In particular, by means of the deformation, dependent on the mass flow, of the at least one deformable portion of the delimiting wall, and in a manner dependent on the physical position of the at least one deformable portion, a virtually constant pressure and/or volume flow can be set in the flow chamber and in particular at the outlet opening. In this way, the fluidic component can be made into a so-called self-regulating system which, despite varying admission pressure or fluid entry pressure, exhibits a virtually constantly high volume flow at the outlet opening and generates a virtually invariant droplet spectrum. Here, in the event of increasing (decreasing) pressure at the inlet opening, the spray angle of the emerging fluid flow may remain virtually constant or decrease (increase). For example, the at least one deformable portion of the delimiting wall may be formed as an elastically deformable wall which delimits the outlet opening (transversely with respect to the fluid flow direction) and which deforms in the event of a change in the fluid pressure at the outlet opening and, in so doing, changes the cross-sectional area of the outlet opening to such an extent that the resulting droplet sizes of the emerging fluid flow are scarcely dependent on the admission pressure, and that the pressure at the outlet opening substantially returns to the previously prevailing level, or remains at said level. In other words, in the case of the self-regulating system, in relation to a virtually rigid, non-variable system, the Sauter diameter of the droplets of the emerging fluid flow decreases to a lesser extent with increasing entry pressure, or remains virtually stable despite an increasing entry pressure.

The material of the at least one deformable portion of the delimiting wall must in this case be selected such that it does not deform in the presence of an arbitrary pressure of the fluid which flows through the fluidic component and which exerts the so-called internal force on the at least one deformable portion, but rather deforms only in a predetermined pressure range or pressure change range. The fluidic component according to the invention can be used for various applications in which, firstly, the dimensions of the fluidic component and, secondly, the volume flow that is to be provided at the outlet opening may vary to a greater or lesser extent. In particular, the narrowest point of the fluidic component through which flow can pass plays a role in terms of the dimensioning. The narrowest point of a fluidic component through which flow can pass is, as viewed in a fluid flow direction, to be understood to mean that point (outside the secondary flow channels) at which the fluidic component has its smallest cross-sectional area extending substantially transversely with respect to the fluid flow direction. The narrowest point may in this case be formed by the inlet opening, the outlet opening or by a point in the main flow channel at which the distance (transversely with respect to the fluid flow direction) between the inner blocks is at its smallest.

Fluidic components for cleaning, wetting, coating or rinsing applications may, at their narrowest point, have a cross-sectional area of 0.005 mm² to 200 mm². For special applications with low throughflow rates, the narrowest point may have a cross-sectional area of 0.005 mm² to 5 mm². In the agricultural sector and for sprinkling tasks, the fluidic component may have a narrowest point with a cross-sectional area of 0.01 mm² to approximately 30 mm². Typical entry pressures for the fluid in this application sector (cross-sectional area of 0.01 mm² to approximately 30 mm²) are 0.25 bar to 16 bar above ambient pressure. For uses of the fluidic components for low-pressure cleaning, entry pressures of 1 bar to 60 bar above ambient pressure are common, wherein the narrowest point may have a cross-sectional area of 0.3 mm² to 200 mm². For uses of the fluidic components for high-pressure cleaning, pressures of 40 bar to approximately 1500 bar above ambient pressure may be used, wherein the narrowest point may assume a cross-sectional area of 0.5 mm² to 180 mm².

In a self-regulating nozzle system which, despite changes in the entry pressure (of the fluid flow entering the fluidic component at the inlet opening), provides a virtually constant volume flow at the outlet opening, the at least one deformable portion of the delimiting wall may be arranged so as to delimit the inlet opening and/or the outlet opening or so as to permit a movement of a movable part of the delimiting wall, wherein the movement leads to a change in the cross-sectional area of the inlet opening and/or of the outlet opening. Accordingly, by means of the physical orientation of the movable part of the delimiting wall, it is possible to determine whether the movement of the movable part of the delimiting wall owing to a deformation (expansion as a result of an increase of the entry pressure) of the at least one deformable portion increases or decreases the cross-sectional area. In addition or alternatively, the inner blocks may have at least one deformable portion at or close to that point in the main flow channel at which the distance (transversely with respect to the fluid flow direction) between the inner blocks is at its smallest, such that a change in the cross-sectional area of this point in the main flow channel is possible. As a material for said at least one deformable portion (of the delimiting wall or of the inner blocks), a material may be used which can expand or contract in accordance with the pressure changes in order to change the size of the cross-sectional areas.

For a fluidic component with a resistance coefficient of 0.89 and a narrowest point (inlet opening, outlet opening or point in the main flow channel) with a cross-sectional area of approximately 0.75 mm², the material should be deformable such that, in the event of a pressure drop by a factor of 100, said cross-sectional area increases in size by a factor of 10. If, in this fluidic component, the pressure at the inlet opening conversely increases by a factor of 100 (for example from 3 bar to 300 bar), said cross-sectional area should decrease in size by a factor of 10 (from approximately 0.75 mm² to approximately 0.075 mm²). The extent of the variation of the cross-sectional area is in particular dependent on the (partially pressure-dependent) resistance coefficient of the fluidic component.

A self-regulating nozzle system may also be designed such that, in the case of varying volume flows at the narrowest point (inlet opening, outlet opening or point in the main flow channel) caused by varying entry pressures, the same pressure dissipation occurs within the fluidic component. For this purpose, in the case of increasing volume flow, the cross-sectional area of the narrowest point should increase in size. For example, the cross-sectional area (1 mm²) increases in size by approximately 14% if, at the narrowest point, the volume flow increases from 1.4 l/min to 1.6 l/min.

For the change in the size of the cross-sectional area of the narrowest point, it is for example possible to utilize geometrical non-linearities, elastically deformable portions of the delimiting wall or of the inner blocks (similarly to the case of flexure hinges), or the so-called fin-ray effect. The increase of the entry pressure can result in an increased (internal) force acting on the delimiting wall and on the inner blocks. Said force provides for a reversible (elastic) deformation of a portion of the wall, which, depending on operating principle, then provides for a deformation of another portion of the wall. A change in the throughflow may furthermore be achieved by means of an adaptation of the pressure loss coefficient. To increase the cross-sectional area of the narrowest point, the wall portion that delimits the narrowest point may be designed so as to elastically or reversibly deform said wall portion in a manner dependent on the increasing pressure, for example by means of the elasticity (flexibility) of the material.

In a further embodiment, the at least one deformable portion of the delimiting wall may form a portion of the at least one secondary flow channel. In the case of two secondary flow channels, two such deformable portions may be provided, such that the two secondary flow channels may be of similar construction. The deformable portion may be designed such that the cross-sectional area of the one or more secondary flow channels can be locally varied (reduced) by deformation of the portion. In this way, in the case of compressible fluids, it is possible in particular for the oscillation frequency of the emerging fluid flow to be varied. In this way, it is furthermore possible for a fan-shaped jet to be generated which is oriented substantially orthogonally with respect to the oscillation plane. As an alternative to the deformation of the delimiting wall in the region of the secondary flow channel, the cross-sectional area of the secondary flow channel may be varied by means of a slide, which can be introduced in targeted fashion into the secondary flow channel. The cross-sectional variation may also be realized by means of a bolt or a threaded rod which can be screwed into the secondary flow channel.

It is furthermore possible for the delimiting wall to comprise at least two parts, wherein one of the two parts is movable relative to the other of the two parts. The movement may in this case be a displacement or a rotation. Here, the axis of rotation may in particular be oriented perpendicular to the oscillation plane. However, the angle between the oscillation plane and the axis of rotation may also deviate from 90°. The displacement may in particular take place in the oscillation plane. However, a displacement that takes place at an angle with respect to the oscillation plane (for example 90°) is conceivable.

In one embodiment, the flow chamber has an outlet channel (directly) upstream of the outlet opening. At its downstream end, the outlet channel opens into the outlet opening. In particular, the outlet channel may be formed so as to be free from obstructions, that is to say no elements which impede or influence the fluid flow are arranged in the outlet channel. As viewed in the oscillation plane, the outlet channel narrows in a downflow direction along the main flow direction. To form the outlet channel, two portions of the delimiting wall above and below the oscillation plane extend substantially parallel to the oscillation plane. These two portions are connected to one another by a further two portions of the delimiting wall, which extend substantially perpendicular to the oscillation plane and which enclose an angle with one another in the oscillation plane. The portions of the delimiting wall that form the outlet channel may be formed together as a single piece. It is also possible for the outlet channel to be formed as a single piece with the rest of the delimiting wall, which forms the rest of the flow chamber. Here, the outlet opening constitutes an interruption of the delimiting wall.

However, the two portions of the delimiting wall that extend substantially perpendicular to the oscillation plane and are part of the outlet channel may be formed as two movable parts (portions) of the delimiting wall which are movable relative to a third part of the delimiting wall (the rest of the outlet channel, the remaining flow chamber or the rest of the delimiting wall).

These two movable parts of the delimiting wall may be rotatable relative to the third part of the delimiting wall. Here, each of the two movable parts may be rotatable independently of the other of the two movable parts relative to the third part of the delimiting wall. Here, the axis/axes of rotation may extend substantially perpendicular to the oscillation plane. By means of the rotation of these two movable parts of the delimiting wall, the angle between the two movable parts of the delimiting wall in the oscillation plane can be varied. This can lead to a variation of the oscillation angle of the emerging fluid flow. Depending on the position of the axes of rotation (in particular the distance thereof to the outlet opening (as viewed in the oscillation plane)), the width of the outlet opening can also be varied by means of the rotation of the two movable parts of the delimiting wall. Here, the width of the outlet opening is the extent of the outlet opening perpendicular to the main flow direction within the oscillation plane. The further remote from the outlet opening the axes of rotation are, the greater the extent to which the width of the outlet opening also changes in the event of a rotation of the two movable parts of the delimiting wall. A variation of the width of the outlet opening can lead to a change in the jet impetus and in the pressure loss at the outlet opening. By means of a reduction of the outlet width, the jet impetus can be increased in the case of an unchanging internal pressure, which can lead to an increase in the cleaning performance by means of the focusing of the jet force. To minimize the coupling between the change in the angle and the outlet width, the axes of rotation may be provided as close as possible to the outlet opening. In order to primarily change the angle between the two movable parts of the delimiting wall without simultaneously influencing the outlet width, an eccentric may be provided instead of an axis of rotation. In the extreme case, it is possible to keep the outlet width constant while said angle is varied.

These two movable parts of the delimiting wall may also be displaceable relative to the third part of the delimiting wall. The displacement may in particular take place in the oscillation plane. Here, the displacement may take place such that the outlet width but not the angle between the two movable parts of the delimiting wall is varied. For example, the displacement may take place along the width of the outlet opening or along those axes in which the planes spanned by the two movable parts of the delimiting wall and the oscillation plane intersect. In the latter case, the width of the outlet opening changes without the cross-sectional area of the secondary flow channel at the entrance of the secondary flow channel being varied. In both cases, the width of the emerging fluid jet can be varied. In one advantageous embodiment, the width of the outlet opening can be varied approximately to the value zero. Alternatively, for the purposes of changing the outlet width, an aperture-like device may be provided which is arranged in the region of the outlet opening and which extends substantially transversely with respect to the main flow direction of the fluid flow. By means of such an aperture, the outlet opening can be varied, in particular reduced in size. Furthermore, a displacement of these two movable parts of the delimiting wall can be performed along the main flow direction in the direction of the inlet opening. Here, the cross-sectional area of the entrance of the at least one secondary flow channel can be reduced. By means of this measure, the oscillation mechanism can be reduced or rendered inactive, such that the emerging fluid jet can be varied between an oscillating fluid jet and a compact, straight fluid jet (or a fluid jet similar to an orifice nozzle).

It is furthermore conceivable for the displacement to take place along the main flow direction of the fluid flow away from the inlet opening. Here, the width of the outlet opening and the angle between the two separate parts of the delimiting wall, which are part of the outlet channel, do not change, but the volume of the outlet channel does change. This can have the effect that the oscillation angle varies only slightly, while the oscillation frequency and the profile with respect to time of the emerging fluid jet vary to a greater extent.

In order to be able to move (rotate or displace) the two movable parts of the delimiting wall relative to the third part of the delimiting wall, a device may be provided which can be actuated by a user. The movement of the two separate parts may in particular take place in a mutually independent manner. Thus, the angle at which the fluid flow emerges from the fluidic component can be varied.

For example, one of the two parts may be moved downstream and the other of the two parts may be moved upstream. Consequently, the angle at which the fluid flow emerges from the fluidic component is diverted in the direction of the part that has been moved upstream.

In one advantageous embodiment, the delimiting wall that forms the outlet channel is manufactured from a different, specifically a harder or more wear-resistant, material than the rest of the delimiting wall. Accordingly, the delimiting wall that forms the outlet channel may be formed from a ceramic material, whereas the rest of the delimiting wall is manufactured from a rust-resistant steel.

In a further embodiment, for the purposes of changing the shape of the flow chamber (and thus for the purposes of changing the spray characteristic of the emerging fluid flow), the at least one inner block may be deformable and/or movable relative to the delimiting wall. In this way, the shape and the volume of the main flow channel and/or of the at least one secondary flow channel can be influenced. By means of this variation, the oscillation angle and the oscillation frequency and the behavior of the emerging fluid jet with respect to time can be varied. The movement may be a rotational movement (about an axis of rotation that extends substantially perpendicular to the oscillation plane) or a displacement (within the oscillation plane). An eccentric may also be provided instead of an axis of rotation.

The at least one inner block may be formed in two parts, such that one part of the inner block is movable relative to the other part of the inner block, or the two parts of the inner block are movable independently of one another relative to the delimiting wall. By movement of the two parts of the at least one inner block with respect to one another, it is for example possible for the shape of the main flow channel to be changed, without influencing the at least one secondary flow channel in the process, and vice versa. Here, a gap or a channel may form between the two parts. The division of the at least one inner block into the two parts may in this case be provided such that the gap formed as a result of the movement does not connect the main flow channel and the at least one secondary flow channel to one another, but rather the gap that forms extends through the at least one inner block from the entrance of the at least one secondary flow channel to the exit of the at least one secondary flow channel. In this way, a leakage flow between the main flow channel and the at least one secondary flow channel is avoided.

In a further embodiment, the at least one inner block may have a channel which extends through the at least one inner block such that the channel fluidically connects the main flow channel and the at least one secondary flow channel to one another. Here, the at least one inner block need not imperatively be constructed in two parts. The channel may also extend in the manner of a pipe through the at least one inner block. By means of the described orientation of the channel from the main flow channel to the at least one secondary flow channel, an additional fluid connection between the main flow channel and the at least one secondary flow channel is provided in a targeted manner. The channel may function as an additional secondary flow channel and thus influence the spray characteristic of the emerging fluid flow. In particular, provision may be made for the channel and/or the at least one secondary flow channel to be closable. It is thus possible for selectively either the channel or the at least one secondary flow channel to be closed, such that the other of the two can be passed through by the fluid and influences the generation of the oscillation.

In one embodiment, the fluidic component has a component length, a component width and a component depth. Here, the component length is defined along a direction which extends substantially from the inlet opening to the outlet opening (the main flow direction of the fluid flow). The component width and the component depth are each defined perpendicularly with respect to one another and with respect to the component length.

In the case of a substantially cuboidal fluidic component, the ratio of component length to component width may amount to 1/3 to 5/1. The ratio preferably lies in the range from 1/1 to 4/1. The component width may lie in a range from 0.1 mm to 1.75 mm. In a preferred design variant, the component width lies between 1.5 mm and 300 mm. The stated dimensions are in particular dependent on the use for which the fluidic component is intended. For example, for cleaning showers in the low-pressure range, the component width typically lies between 4 mm and 50 mm.

The extent of the flow chamber along the component length, the component depth or the component width may be variable. In this way, it is possible in particular for the volume of the flow chamber to be changed. With increasing component length, the jet profile with respect to time can be approximated to a rectangular function. By means of a further lengthening of the component length, the oscillation angle can be reduced, as far as the limit case in which a quasistatic orifice jet is realized.

The delimiting wall may, for the purposes of changing the component length, depth or width, be of telescopic or bellows-like form. Here, it is also possible for the length, depth or width of the at least one inner block to be variable (by means of a telescopic or bellows-like construction). Here, the delimiting wall and the at least one inner block can be varied independently of one another. In one advantageous embodiment, either the length of the at least one inner block or the length of the flow chamber is varied.

A change of the component length may take place in particular in the region of the outlet channel. This means that the outlet channel can, with shortening of the component length by means of a telescopic construction, be moved in the direction of the inlet opening along the main flow direction or, with lengthening of the component length, be moved away from the inlet opening along the main flow direction.

The outlet opening may be adjoined, downstream, by an outlet widening. The outlet widening may comprise two portions of the delimiting wall which extend substantially perpendicular to the oscillation plane. These two portions may be formed so as to be movable relative to the rest of the delimiting wall. Here, the two movable portions of the delimiting wall may be oriented so as to enclose an angle in the oscillation plane, wherein the outlet widening widens in a downstream direction along the width of the outlet opening. Here, the angle between the two movable portions of the delimiting wall, which are part of the outlet widening, may be variable. For this purpose, the movable portions may be rotatable about an axis which extends substantially perpendicular to the oscillation plane. By means of a change in the angle between the movable portions, the oscillation angle of the emerging fluid flow can be varied. The outlet widening should have a length (along the component length) which is at least 25% of the width of the outlet opening. By means of the outlet widening, the spray jet is guided within the oscillation plane, which leads to an increase of the spray impetus.

An outlet channel may be provided upstream of the outlet opening, and an outlet widening may be provided downstream of the outlet opening. Here, the outlet opening may form the transition between the outlet channel and the outlet widening. The transition may in particular be formed by a radius. A radius is to be understood here to mean a circular arc of a circular portion. In one embodiment, the magnitude of the radius in the oscillation plane is variable. If the radius is equal to zero, then the outlet opening is formed by a sharp edge. By enlargement of the radius, the droplet spectrum can be shifted in the direction of smaller droplets. In the event of a change in the radius, it is in particular possible for the shape of the outlet channel that adjoins the outlet opening in an upstream direction and/or the shape of the outlet widening that adjoins the outlet opening in a downstream direction to also change. Furthermore, the width of the outlet opening (that is to say the extent thereof in the oscillation plane transversely with respect to the fluid flow direction) can be changed simultaneously with the change in the radius. By means of a change in the radius, not only the droplet spectrum but also the spray angle and/or the fluid distribution within the spray fan of the emerging fluid flow can be varied. The radius may also be changed into some other rounded shape, which may be constituted for example by a polygon. Here, the abovementioned angle of the outlet widening may also change.

For the change in the radius, it is for example possible for a plunger device to be provided, which plunger device is integrated into a wall, which extends parallel to the oscillation plane, of the fluidic component and which plunger device can be displaced perpendicularly with respect to the oscillation plane. The plunger device may have a multiplicity of shapes for the purposes of configuring the radius of the outlet opening, which shapes can be moved into the oscillation plane as required.

Alternatively, for the purposes of changing the radius, provision may be made whereby, in the region of the outlet opening and possibly in the adjoining region of the outlet channel and/or of the outlet widening, the material of the respective wall (which extends substantially perpendicular to the oscillation plane) is elastically deformable. For this purpose, the elastic material may have a spring sheet or an elastic plastic. For the deformation of the elastic material, a body which is displaceable in the oscillation plane may be provided, which body can, by displacement, exert a force on the elastic material and thus effect a deformation of the elastic material, changing the radius of the outlet opening.

The angle enclosed by the walls of the outlet widening which adjoins the outlet opening in a downstream direction, which walls extend substantially perpendicular to the oscillation plane, may be changed simultaneously with the change in the radius. The change in angle may be realized, with deformation of the elastically deformable material in the region of the outlet widening which adjoins the outlet opening, by means of an action of force, or displacement, of a body transversely with respect to or in the oscillation plane. Depending on the physical embodiment of the flow chamber of the fluidic component, the spray angle of the fluid jet can be changed by means of the change in angle of the outlet widening and the change in radius of the outlet opening. Thus, by enlargement of the radius, the fraction of relatively small droplets in the emerging fluid flow can be increased, and thus the Sauter diameter of the droplets can be reduced, which is advantageous for example for wetting and coating processes.

In a further embodiment, the inlet opening may have a variable width. Here, the width of the inlet opening is defined substantially perpendicularly with respect to the main flow direction of the fluid flow within the oscillation plane. By means of a variation of the width of the inlet opening, the spray characteristic of the emerging fluid flow can be set between a virtually punctiform jet and an oscillating fluid jet, wherein the oscillating fluid jet may be regarded as a fan-shaped jet. It is thus for example possible for the output per unit of area of the fluidic component to be set in accordance with the field of use.

In a further embodiment, the flow chamber has at least two secondary flow channels connected in parallel as means for generating an oscillation of the fluid flow at the outlet opening. Here, the at least two secondary flow channels connected in parallel have different shapes. At a given point in time, only one of the at least two secondary flow channels connected in parallel can be flowed through by the fluid flow. This means that the at least two secondary flow channels connected in parallel cannot be flowed through simultaneously by the fluid flow. Depending on the desired profile of the emerging fluid flow, a secondary flow channel with a particular shape may be selected for the throughflow. In order to close the secondary flow channels, a displaceable partition may be provided which, by means of a closing mechanism, can be pushed transversely with respect to the fluid flow direction into a secondary flow channel so as to close the secondary flow channel over the entire cross section. Here, provision may be made whereby, when one (specifically exactly one) of the at least two secondary flow channels connected in parallel is opened up, the one or more others of the at least two secondary flow channels connected in parallel is or are simultaneously closed.

The at least two secondary flow channels connected in parallel form a unit. For example, the fluidic component may comprise two such units, wherein the main flow channel is arranged for example between the two units. In this case, always two secondary flow channels are opened up for the throughflow, wherein the two secondary flow channels belong to in each case one unit.

A unit may for example comprise two secondary flow channels connected in parallel. There may however also be more than two. The secondary flow channels, connected in parallel, of a unit may be arranged in a plane, which for example corresponds to the oscillation plane. However, the secondary flow channels connected in parallel may, in order to save space, be arranged in different planes. This arrangement may be of particular interest if a unit comprises more than two secondary flow channels connected in parallel, or if a relatively long secondary flow channel is provided.

Through selection of the shape of a secondary flow channel, and in particular by means of a change in the length of a secondary flow channel, the oscillation frequency of the emerging fluid flow can be varied. If, for example, a switch is made from a relatively short secondary flow channel to a relatively long secondary flow channel, the oscillation frequency is reduced.

The at least one secondary flow channel or the at least two secondary flow channels connected in parallel may have each one entrance and each one exit and may extend between the respective entrance and the respective exit. Here, said entrance and exit constitute the transition at which the main flow channel is fluidically connected to the secondary flow channels. In one embodiment, in the region of at least one entrance and/or of at least one exit, one or more elements project into the flow chamber such that it/they can be flowed around by the fluid flow. Here, the at least one element is adjustable in position within the region of the at least one entrance and/or of the at least one exit. For the adjustment of the position, an adjusting device may be provided which is suitable for adjusting the at least one element (in continuously variable fashion). Here, the at least one element may be displaceable in the oscillation plane or may be rotatable about an axis which extends substantially perpendicular to the oscillation plane. Here, the axis of rotation may run through the center of the respective element, or eccentrically. The adjustability of the position is in this case restricted to the at least one element remaining in the region of the respective entrance or exit. In particular, the at least one element is not adjustable such that it passes into the outlet channel situated upstream of the outlet opening. Alternatively or in addition, the at least one element may be adjustable in terms of its position such that it is movable (by means of a translational or screwing movement), in the manner of a plunger, into the flow chamber transversely with respect to the oscillation plane. For this purpose, the corresponding front or rear wall, which delimits the flow chamber, of the fluidic component may be of elastic form in certain portions. Thus, the at least one element can be adjustable (in continuously variable fashion) between two maximum deflections, at which the at least one element either extends over the entire depth of the fluidic component or does not project into the flow chamber at all.

The at least one element may have various shapes. For example, it may (as viewed in the oscillation plane) have a circular, elliptical, sickle-shaped or polygonal cross section, or mixed forms of these. Here, a rotatable element has in particular a rotationally asymmetrical shape. If multiple elements are provided, these may differ in terms of shape and/or adjustability (translation, rotation). By changing the position of the at least one element, the jet characteristic of the fluid flow emerging from the fluidic component can be changed. By means of the at least one adjustable element, the flow is influenced to such an extent that the spray angle and/or the profile with respect to time of the emerging fluid flow change(s).

The at least one element extends preferably over the entire depth of the fluidic component, that is to say over the entire extent of the fluidic component perpendicular to the oscillation plane. However, the at least one element may extend only over a portion of the depth.

In a further embodiment, the fluidic component has at least two secondary flow channels, which can be flowed through simultaneously by a fluid flow. Here, each of the at least two secondary flow channels has an opening. Via the openings, the at least two secondary flow channels are connected to a connecting channel, which is designed to be closable. To close the connecting channel, at least one partition may be provided which is movable into the connecting channel and out of the latter again. In particular, multiple partitions may be provided which correspond in number to the number of openings of the at least two secondary flow channels. Here, the partitions may be arranged respectively in the region of an opening of the at least two secondary flow channels in order to close or open up the openings. If the connecting channel is not closed, it fluidically connects the at least two secondary flow channels to one another. In this way, the oscillation frequency of the emerging fluid flow (and thus the shape of the spray fan) are reduced, and the spray angle is influenced. If the connecting channel is closed, the fluid flows only through the at least two secondary flow channels and the main flow channel.

The various embodiments of the fluidic component may also be combined with one another in order to realize a desired spray characteristic.

The movement or deformation of individual elements of the fluidic component (for the purposes of deforming the flow chamber) is realized in all embodiments by means of a device which exerts a force on the corresponding element in targeted fashion and thereby effects the movement or deformation respectively. Said device is designed to reverse the movement or deformation respectively.

The invention furthermore relates to a fluidic assembly as per the preamble of claim 19. Accordingly, the fluidic assembly comprises the fluidic component according to the invention and a sealing body into which the fluidic component is embedded. Here, the sealing body seals off the entire fluidic component with the exception of the inlet opening and the outlet opening of the fluidic component. By means of the sealing body, it can be achieved that, in the event that a leak arises during a variation of the shape of the flow chamber, the fluid cannot enter the flow chamber or exit the flow chamber outside the inlet opening and the outlet opening. The sealing body may comprise a flexible material, for example a flexible plastics material, which is suitable for deforming, in particular expanding, in the event of a corresponding variation of the shape of the flow chamber.

The invention furthermore relates to a fluid-distributing appliance which comprises the fluidic component according to the invention or the fluidic assembly according to the invention. The fluid-distributing appliance may in particular be a cleaning appliance or a watering appliance. The watering appliance may be used for example in irrigation systems, lawn sprinklers or handheld showers.

The invention will be discussed in more detail below on the basis of exemplary embodiments in conjunction with the drawings, in which:

FIG. 1 shows a cross section through a fluidic component parallel to the oscillation plane;

FIG. 2 shows a sectional illustration of the fluidic component from FIG. 1 along the line A′-A″;

FIG. 3 shows a sectional illustration of the fluidic component from FIG. 1 along the line B′-B″;

FIG. 4 shows a cross section through a fluidic component parallel to the oscillation plane with a variable outlet channel according to an embodiment of the invention;

FIG. 5 shows a cross section through a fluidic component parallel to the oscillation plane with a variable outlet channel according to a further embodiment of the invention;

FIG. 6 shows a cross section through a fluidic component parallel to the oscillation plane with a variable outlet channel according to a further embodiment of the invention;

FIG. 7 shows a cross section through a fluidic component parallel to the oscillation plane with a variable outlet channel according to a further embodiment of the invention;

FIG. 8 shows a cross section through a fluidic component parallel to the oscillation plane with rotatable inner blocks according to an embodiment of the invention;

FIG. 9 shows a cross section through a fluidic component parallel to the oscillation plane with rotatable inner blocks according to a further embodiment of the invention;

FIG. 10 shows a cross section through a fluidic component parallel to the oscillation plane with a deformable inner block and a two-part inner block according to an embodiment of the invention;

FIG. 11 shows a cross section through a fluidic component parallel to the oscillation plane with a deformable delimiting wall of the flow chamber according to an embodiment of the invention;

FIG. 12 shows a cross section through a fluidic component parallel to the oscillation plane with a variable inlet opening according to an embodiment of the invention;

FIG. 13 shows a cross section through a fluidic component parallel to the oscillation plane with a variable component length according to an embodiment of the invention;

FIG. 14 shows a cross section through a fluidic component corresponding to the view from FIG. 3 with a variable component depth according to an embodiment of the invention;

FIG. 15 shows a cross section through a fluidic component parallel to the oscillation plane with inner blocks extended through by a channel according to an embodiment of the invention;

FIG. 16 shows a cross section through a fluidic component parallel to the oscillation plane with deformable inner blocks according to an embodiment of the invention;

FIG. 17 shows a cross section through a fluidic component parallel to the oscillation plane with a variable outlet widening according to an embodiment of the invention;

FIG. 18 shows a cross section through a fluidic component parallel to the oscillation plane with a variable outlet opening according to an embodiment of the invention;

FIG. 19 shows a cross section through a fluidic component parallel to the oscillation plane with two units, which comprise each two secondary flow channels connected in parallel, according to an embodiment of the invention;

FIG. 20 shows a cross section through a fluidic component parallel to the oscillation plane with a multiplicity of elements, around which flow can pass, according to an embodiment of the invention;

FIG. 21 shows a cross section through a fluidic component parallel to the oscillation plane with an additional channel, which connects two secondary flow channels, according to an embodiment of the invention; and

FIG. 22 shows a sectional illustration of the fluidic component from FIG. 21 along the line A′-A″.

FIG. 1 schematically illustrates a cross section through a fluidic component parallel to its oscillation plane. FIGS. 2 and 3 show a sectional illustration of said fluidic component 1 along the lines A′-A″ and B′-B″ respectively. The fluidic component 1 comprises a flow chamber 10 which can be flowed through by a fluid flow. The flow chamber 10 is also known as interaction chamber. The flow chamber 10 is formed by a delimiting wall 5.

The flow chamber 10 comprises an inlet opening 101, via which the fluid flow enters the flow chamber 10, and an outlet opening 102, via which the fluid flow emerges from the flow chamber 10. The inlet opening 101 and the outlet opening 102 are arranged on two sides of the fluidic component 1, which are situated oppositely (in terms of flow), between a front wall 12 and a rear wall 13. The front wall 12 and the rear wall 13 are a part of the delimiting wall 5 of the flow chamber 10. The fluid flow 2 moves in the flow chamber 10 substantially along a longitudinal axis A of the fluidic component 1 (which connects the inlet opening 101 and the outlet opening 102 to one another) from the inlet opening 101 to the outlet opening 102. The inlet opening 101 has an inlet width b_{IN} and the outlet opening 102 has an outlet width b_{EX}. The widths are defined, in the oscillation plane, substantially perpendicularly with respect to the longitudinal axis A.

The flow chamber 10 comprises a main flow channel 103 which extends centrally through the fluidic component 1. The main flow channel 103 extends substantially rectilinearly along the longitudinal axis A, such that the fluid flow in the main flow channel 103 flows substantially along the longitudinal axis A of the fluidic component 1. At its downstream end, the main flow channel 103 transitions into an outlet channel 107, which narrows in a downstream direction as viewed in the oscillation plane and ends in the outlet opening 102.

To generate an oscillation of the fluid flow at the outlet opening 102, the flow chamber 10 comprises, by way of example, two secondary flow channels 104a, 104b, wherein the main flow channel 103 is arranged (as viewed transversely with respect to the longitudinal axis A) between the two secondary flow channels 104a, 104b. Directly downstream of the inlet opening 101, the flow chamber 10 divides into the main flow channel 103 and the two secondary flow channels 104a, 104b, which are then merged upstream of the outlet opening 102. The two secondary flow channels 104a, 104b are in this case, by way of example, of identical shape and arranged symmetrically with respect to the longitudinal axis A (FIG. 1). In an alternative which is not illustrated, the secondary flow channels may be arranged asymmetrically.

Proceeding from the inlet opening 101, the secondary flow channels 104a, 104b, in a first portion, each initially extend in opposite directions at an angle of substantially 90° with respect to the longitudinal axis A. The secondary flow channels 104a, 104b subsequently bend such that they each extend substantially parallel to the longitudinal axis A (in the direction of the outlet opening 102) (second portion). In order to merge the secondary flow channels 104a, 104b and the main flow channel 103 again, the secondary flow channels 104a, 104b change their direction once again at the end of the second portion, such that said secondary flow channels are each directed substantially in the direction of the longitudinal axis A (third portion). In the embodiment of FIG. 1, the direction of the secondary flow channels 104a, 104b at the transition from the second to the third portion changes by an angle of approximately 120°. However, it is also possible for angles other than that stated here to be selected for the change in direction between said two portions of the secondary flow channels 104a, 104b.

The secondary flow channels 104a, 104b are a means for influencing the direction of the fluid flow that flows through the flow chamber 10, and ultimately a means for generating an oscillation of the fluid flow at the outlet opening 102. For this purpose, the secondary flow channels 104a, 104b have each one entrance 104a1, 104b1, which is formed by that end of the secondary flow channels 104a, 104b which faces toward the outlet opening 102, and each one exit 104a2, 104b2, which is formed by that end of the secondary flow channels 104a, 104b which faces toward the inlet opening 101. A small part of the fluid flow, the secondary flows, flows through the entrances 104a1, 104b1 into the secondary flow channels 104a, 104b. The remaining part of the fluid flow (the so-called main flow) exits the fluidic component 1 via the outlet opening 102. The secondary flows emerge from the secondary flow channels 104a, 104b at the exits 104a2, 104b2, where they can impart a lateral impetus (transversely with respect to the longitudinal axis A) on the fluid flow entering through the inlet opening 101. Here, the direction of the fluid flow is influenced such that the main flow emerging at the outlet opening 102 spatially oscillates, specifically in a plane, the so-called oscillation plane, in which the main flow channel 103 and the secondary flow channels 104a, 104b are arranged. The oscillation plane is parallel to the main extent plane of the fluidic component 1. The moving emerging fluid jet oscillates within the oscillation plane with the so-called oscillation angle.

In an alternative which is not illustrated, it is possible instead of the secondary flow channels to use other means for generating the oscillation of the emerging fluid jet. Examples for this are edges which extend into the flow chamber 10, or steps which are visible to the fluid flow, in order to thus generate a periodically detaching flow within the component 1. To intensify this periodically oscillating flow, the flow chamber 10 is shaped such that so-called recirculation areas can alternately build up and dissipate within this flow chamber. It is also possible for the secondary flow channels to be arranged asymmetrically with respect to the longitudinal axis A. Furthermore, the secondary flow channels may also be positioned outside the illustrated oscillation plane. Said channels may for example be realized by hoses outside the oscillation plane, or by channels which run at an angle with respect to the oscillation plane.

In the design variant illustrated here, the secondary flow channels 104a, 104b each have a cross-sectional area which is virtually constant over the entire length (from the entrance 104a1, 104b1 to the exit 104a2, 104b2) of the secondary flow channels 104a, 104b. In a design variant which is not illustrated here, the cross-sectional areas may be non-constant. By contrast, the size of the cross-sectional area of the main flow channel 103 increases substantially steadily in the flow direction of the main flow (that is to say in the direction from the inlet opening 101 to the outlet opening 102).

The main flow channel 103 is separated from each secondary flow channel 104a, 104b by an inner block 11a, 11b. In the embodiment from FIG. 1, the two blocks 11a, 11b are identical in shape and size and arranged symmetrically with respect to the longitudinal axis A. In principle, however, they may also be designed differently and/or be oriented asymmetrically. In the case of an asymmetrical orientation, the shape of the main flow channel 103 is also asymmetrical with respect to the longitudinal axis A. The shape of the blocks 11a, 11b illustrated in FIG. 1 is merely an example, and may be varied. The blocks 11a, 11b from FIG. 1 have rounded edges. Thus, the blocks 11a, 11b each have a radius 119 at their end facing toward the inlet opening 101 and the main flow channel 103. The edges may also be sharp. In the downstream direction, the distance of the two inner blocks 11a, 11b to one another along the component width b steadily increases, such that (as viewed in the oscillation plane) said blocks enclose a wedge-shaped main flow channel 103. The shape of the main flow channel 103 is formed in particular by those surfaces 110a, 110b of the blocks 11a, 11b which point inward (in the direction of the main flow channel 103) and which extend substantially perpendicularly with respect to the oscillation plane. The angle enclosed by the inwardly pointing surfaces 110a, 110b is in this case denoted as γ. The inwardly pointing surfaces 110a, 110b may have a (slight) curvature or be formed by one or more radii, a polynomial and/or one or more straight lines, or by a mixed form of these. The blocks 11a, 11b furthermore have surfaces 111a, 111b pointing outward (in the direction of the secondary flow channels 104a, 104b).

At the entrance 104a1, 104b1 of the secondary flow channels 104a, 104b, there are provided separators 105a, 105b in the form of indentations (into the flow chamber). From the perspective of the flow, the separators are protuberances. Here, at the entrance 104a1, 104b1 of each secondary flow channel 104a, 104b, respectively one indentation 105a, 105b projects beyond a portion of the circumferential edge of the secondary flow channel 104a, 104b into the respective secondary flow channel 104a, 104b and, at this location, changes the cross-sectional shape thereof, with a decrease in size of the cross-sectional area. In FIG. 1, the portion of the circumferential edge has been selected such that each indentation 105a, 105b is (inter alia also) directed toward the inlet opening 101 (in a manner oriented substantially parallel to the longitudinal axis A). Depending on the usage situation, the separators 105a, 105b may also be oriented differently, or else omitted entirely. It is also possible for a separator 105a, 105b to be provided only at one of the secondary flow channels 104a, 104b. The separation of the secondary flows from the main flow is influenced and controlled by means of the separators 105a, 105b. By means of the shape, size and orientation of the separators 105a, 105b, the quantity of fluid that flows into the secondary flow channels 104a, 104b, and the direction of the secondary flows, can be influenced. This in turn leads to influencing of the exit angle of the main flow at the outlet opening 102 of the fluidic component 1 (and thus to influencing of the oscillation angle) and of the frequency with which the main flow oscillates at the outlet opening 102. Through selection of the size, orientation and/or shape of the separators 105a, 105b, it is thus possible for the profile of the main flow emerging at the outlet opening 102 to be influenced in a targeted manner. It is particularly advantageous if the separators 105a, 105b are (as viewed along the longitudinal axis A) arranged downstream of the position where the main flow detaches from the inner blocks 11a, 11b and a part of the fluid flow enters the secondary flow channels 104a, 104b.

Positioned upstream of the inlet opening 101 of the flow chamber 10 is a funnel-shaped extension 106 which (in the oscillation plane) narrows in the direction of the inlet opening 101 (in the downstream direction). Also, upstream of the outlet opening 102, the flow chamber 10 narrows (in the oscillation plane). The narrowing is formed by the abovementioned outlet channel 107, which extends between the entrances 104a1, 104b1 of the secondary flow channels 104a, 104b and the outlet opening 102. In FIG. 1, the entrances 104a1, 104b1 of the secondary flow channels 104a, 104b are predefined by the separators 105a, 105b. Here, the funnel-shaped extension 106 and the outlet channel 107 narrow such that only the width thereof, that is to say the extent thereof in the oscillation plane perpendicular to the longitudinal axis A, decreases in the downstream direction respectively. Additionally, the funnel-shaped extension 106 and the outlet channel 107 may, in the downstream direction, also narrow along the component depth, that is to say perpendicular to the oscillation plane and perpendicular to the longitudinal axis A. Furthermore, it is possible for only the extension 106 to narrow in the depth direction or in the width direction, whereas the outlet channel 107 narrows both in the width direction and in the depth direction, and vice versa. The extent of the narrowing of the outlet channel 107 influences the alignment characteristic of the fluid flow emerging from the outlet opening 102, and thus the oscillation angle thereof. The shape of the funnel-shaped extension 106 and of the outlet channel 107 are shown merely by way of example in FIG. 1. Here, the width thereof decreases respectively linearly in the downstream direction. Other shapes of the narrowing are possible. The length l₁₀₆ of the funnel-shaped extension 106 corresponds in this embodiment to at least 1.5 times the width b_{IN} of the inlet opening 101 (l₁₀₆>1.5·b_{IN}).

The outlet channel 107 is formed by portions of the delimiting wall 5. Here, two portions of the delimiting wall 5 are perpendicular to the oscillation plane and enclose an angle δ in the oscillation plane. These two portions are each formed as planar surfaces. Alternatively, these two portions may be formed by curved surfaces.

The inlet opening 101 and the outlet opening 102 each have a rectangular cross-sectional area (transversely with respect to the longitudinal axis A). These each have the same depth t but differ in terms of their width b_{IN}, b_{EX}. Alternatively, a non-rectangular cross-sectional area is also conceivable for the inlet opening 101 and the outlet opening 102.

The distance between the inlet opening 101 and the outlet opening 102 (the component length l) may have a ratio to the component width b of 1/3 to 4/1, preferably of 1/1 to 4/1. The component width b may lie in the range from 0.1 mm to 1.75 m. In a preferred design variant, the internal component width bᵢ lies between 1.5 mm and 150 mm. The width b_{EX} of the outlet opening 102 amounts to 1/3 to 1/50 of the component width b, preferably 1/5 to 1/20. The width b_{EX} of the outlet opening 102 is selected in a manner dependent on the volume throughflow, the component depth t, the entry speed of the fluid and/or the entry pressure of the fluid, and the desired oscillation frequency. The width b_{IN} of the inlet opening 101 amounts to 1/3 to 1/30 of the component width b, preferably 1/5 to 1/15.

In FIG. 1 (and also in FIG. 13), the fluidic component 1 has an additional outlet widening 108 downstream of the outlet opening 102. Said outlet widening 108 has the length l₁₀₈ in the oscillation plane and as viewed along the longitudinal axis A and widens (in the oscillation plane transversely with respect to the longitudinal axis A) in the downstream direction proceeding from the outlet opening 102. The jet quality of the oscillating fluid jet is positively influenced by the length l₁₀₈ of the outlet widening 108. The greater the length l₁₀₈, the more intensely the emerging fluid jet is focused. It is preferable if l₁₀₈ corresponds to at least ¼ of the width b_{EX} of the outlet opening 102. The additional outlet widening 108 is optional. It may thus be omitted depending on the field of application. In particular, the exemplary embodiments illustrated in the figures are not restricted to the specific illustration with or without an outlet widening. Exemplary embodiments without an outlet widening may be provided with an outlet widening, and vice versa.

The outlet widening 108 is formed by portions of the delimiting wall 5. Here, two portions 53a, 53b of the delimiting wall 5 are perpendicular to the oscillation plane and enclose an angle ε in the oscillation plane. Said two portions 53a, 53b are each formed as planar surfaces. Alternatively, said two portions may be formed by curved surfaces. The angle ε may have different values. In particular, the angle ε may be set in a manner dependent on the desired oscillation angle of the fluid flow. Preferably, the angle ε is greater than the oscillation angle of the fluid flow by at least 8° in order to obtain a fluid jet which moves in an undisrupted manner. In order to obtain a defined oscillation angle or in order to restrict the oscillation angle, an angle ε less than or equal to the oscillation angle of the freely oscillating fluid jet (without outlet widening) is advantageous.

The outlet opening 102 defines the transition between the outlet channel 107 and the outlet widening 108. The transition may be formed by a radius 109. Said radius 109 is preferably smaller than the width b_{IN} of the inlet opening 101 or the width b₁₀₃ of the main flow channel 103 at its narrowest point in the oscillation plane. Here, the narrowest point of the main flow channel 103 in the oscillation plane is the point at which the distance between the inner blocks 11a, 11b in the oscillation plane and transversely with respect to the longitudinal axis A is at its smallest. If the radius 109 is equal to 0, then the outlet opening 102 is sharp-edged. However, owing to the greater mechanical stability, a radius 109 with a value greater than zero is preferred.

As per FIG. 2, the fluidic component 1 from FIG. 1 has a constant component depth t. The component depth t may however also vary along the longitudinal axis A. FIG. 3 illustrates a section through the fluidic component 1 from FIG. 1 along the axis B′-B″. FIG. 3 shows that the cross-sectional areas of the main flow channel 103 and of the secondary flow channels 104a, 104b are each substantially rectangular. Such cross-sectional shapes are easy to manufacture. However, the cross-sectional areas may also have other shapes; for example, the secondary flow channels 104a, 104b may have a triangular, polygonal or circular cross-sectional area.

On the basis of the fluidic component 1 illustrated in FIGS. 1 to 3, the components, of which some are also optional, of a fluidic component 1 with secondary flow channels as a means for generating an oscillation have been described. The optional components include in particular the funnel-shaped extension 106, the separators 105a, 105b and the outlet widening 108. The shape of the flow chamber 10 of the fluidic component 1 is variable. The manner in which a variation of the shape can be achieved will be described below on the basis of FIGS. 4 to 22. Even if the geometry of the fluidic component in FIGS. 4 to 22 does not correspond in all details to the geometry of the fluidic component from FIGS. 1 to 3, the features from FIGS. 4 to 22 with regard to the deformability of the flow chamber 10 are nevertheless transferable to the fluidic component from FIGS. 1 to 3. Features from FIGS. 4 to 22 may also be combined with one another.

With regard to the possibilities, illustrated in FIGS. 4 to 22, for the variation of the shape of the flow chamber 10, the corresponding effect on the fluid flow will generally also be described. Owing to the non-linear flow characteristic of a fluid in the fluidic component, however, no general statement regarding the result of the spray pattern is possible.

The fluidic component 1 from FIG. 4 has (by contrast to the fluidic component 1 from FIGS. 1 to 3) no separators and no outlet widening. The outlet channel 107 extends from the entrances 104a1, 104b1 of the secondary flow channels 104a, 104b to the outlet opening 102. For the purposes of varying the shape of the flow chamber, it is the case in the embodiment from FIG. 4 that portions (parts) of the delimiting wall 5 which extend substantially perpendicular to the oscillation plane and which delimit the outlet channel 107 are designed to be movable. The movable portions (parts) of the delimiting wall 5 are denoted by the reference designations 51a, 51b. The movable portions (parts) 51a, 51b are each mounted so as to be rotatable about an axis of rotation Ra, Rb, which extends substantially perpendicular to the oscillation plane. By means of a device (not illustrated), the movable portions (parts) 51a, 51b can be rotated about the axes of rotation Ra, Rb. The movable portions (parts) 51a, 51b are rotatable independently of one another, but may also be rotated in a coupled manner. The axes of rotation Ra, Rb are arranged close to the entrances 104a1, 104b1 of the secondary flow channels 104a, 104b.

As an alternative to the embodiment from FIG. 4, the parts 51a, 51b, rather than being rotatable about a fixed axis of rotation Ra, Rb, may each have at least one deformable portion in order to permit a rotation of the parts 51a, 51b and a deformation of the outlet channel 107. Here, the parts 51a, 51b may, at least in certain portions, be of elastically reversibly deformable form. Thus, in a manner dependent on the mass flow (referred to further above as internal force) (or on the pressure) of the fluid flow entering the fluidic component, the shape of the at least one deformable portion, and thus the orientation of the parts 51a, 51b, can be varied. Thus, the parts 51a, 51b can, in a manner dependent on the mass flow, function in the manner of a flexure hinge and perform a rotational movement with expansion or compression of the respective at least one deformable portion. It is for example possible here, in a manner dependent on the specific geometrical design of the parts 51a, 51b and on the specific arrangement of the deformable portions within the parts 51a, 51b, for the cross-sectional area of the outlet opening 102 to increase or decrease in size in the event of pressure changes within the fluidic component 1. Thus, in the case of a rising entry pressure, the cross-sectional area of the outlet opening can increase in size. In this way, the tendency for smaller droplets to be generated in the presence of higher entry pressures can be counteracted. It can thus be achieved that, through variation of the size of the cross-sectional area of the outlet opening, the resulting droplet sizes are scarcely dependent on the admission pressure. Furthermore, in such a self-regulating system, the volume flow at the outlet opening can be kept virtually constant despite changes in the admission pressure. Depending on the design of the outlet channel 107, it is possible for the oscillation angle, and thus for the most part also the spray angle, to be reduced with increasing entry pressure.

The movable portions 51a, 51b in the embodiment of FIG. 4 can rotate through an angle between two maximum deflection positions, of which one is illustrated in FIG. 4 by a solid line, and the other is illustrated by a dashed line. The maximum deflection positions are illustrated by way of example in FIG. 4. The movable portions 51a, 51b can assume any position between the two maximum deflection positions in continuously variable fashion. A rotation causes the orientation of the movable portions 51a, 51b with respect to one another and with respect to the rest of the delimiting wall 5 to change. Here, the angle δ of the outlet channel 107 changes. Furthermore, the width b_{EX} of the outlet opening 102 changes. In order to move from the maximum deflection position illustrated by a solid line to the other maximum deflection position (illustrated by dashed lines), the movable portions 51a, 51b are rotated such that (with an increase of the width b_{EX} of the outlet opening 102) the outlet opening 102 moves downstream. In this way, the component length l is also varied (increased). By means of the rotation of the movable portions 51a, 51b, the oscillation angle of the emerging fluid flow, and the possible throughflow, can be influenced. Additionally, the volume of the outlet channel 107 varies. The angle between the two maximum deflection positions and the position of the two maximum deflection positions with respect to the longitudinal axis A can be selected in accordance with the field of use.

The delimiting wall 5 of the flow chamber 10 is formed by the inner surface of a hollow body, wherein the cavity of the hollow body forms the flow chamber 10. The delimiting wall 5 is connected to the outer surface, which determines the external appearance of the fluidic component, of the hollow body. In FIG. 4, the movable portions 51a, 51b of the delimiting wall 5 are connected to corresponding portions of the outer surface of the hollow body and are rotatable together therewith. Accordingly, the external appearance of the fluidic component also varies in the event of rotation of the movable portions 51a, 51b. Alternatively, the angle δ between the movable portions 51a, 51b of the delimiting wall 5 may be varied for example by deformation of the inner surface of the hollow body in the region of the outlet channel 107.

Depending on the position of the axes of rotation Ra, Rb, which in turn is dependent on the shape of the inner blocks 11a, 11b, on the shape or the presence of separators and on the fluid characteristics (type of the fluid, entry pressure and volume flow), the emerging fluid jet may exhibit an intense and/or abrupt change in acceleration or a virtually invariant profile with respect to time without abrupt changes in acceleration. Thus, the fluid distribution can be varied to a minimal extent within the spray fan within the oscillation angle.

For certain applications, a jet with edge emphasis is desirable, that is to say an oscillating jet which, averaged over time, remains for longer in the outer region than in the inner region of the spray fan. To generate such a jet, the position of the axes of rotation Ra, Rb, the shape of the inner blocks 11, the shape of the separators 105a, 105b (if present), the type of the fluid, the entry pressure and the volume flow may be selected such that, averaged over time, the fluid flow is in contact with the outlet channel 107 (with those portions 51a, 51b of the delimiting wall 5 which are oriented perpendicular to the oscillation plane and which are part of the outlet channel 107) for as long as possible. To generate a jet with edge emphasis, it is furthermore possible for the angle ε of the outlet widening 108 (if present) to be set to be smaller than the free oscillation angle of the fluid flow without the outlet widening 108.

The embodiment from FIG. 5 differs from that from FIG. 4 in particular by the position of the axes of rotation Ra, Rb. In relation to FIG. 4, the distance between the axes of rotation Ra, Rb and the outlet opening 102 is smaller in FIG. 5. In this embodiment, the volume of the outlet channel 107 and the width b_{EX} of the outlet opening 102 change to a lesser extent (in relation to FIG. 4) if the movable portions 51a, 51b are rotated through a defined angle. The movable portions 51a, 51b may rotate through an angle between two maximum deflection positions, of which one is illustrated in FIG. 5 by a solid line and the other is illustrated by a dashed line. The movable portions 51a, 51b may assume any position between the two maximum deflection positions in continuously variable fashion. In order to move from the maximum deflection position illustrated by a solid line to the other maximum deflection position (illustrated by dashed lines), the movable portions 51a, 51b are rotated such that (with variation (a decrease of a portion and an increase of a portion) of the width b_{EX} of the outlet opening 102) the outlet opening 102 moves upstream. The angle between the two maximum deflection positions and the position of the two maximum deflection positions with respect to the longitudinal axis A may be selected in accordance with the field of use. The rotation of the movable portions 51a, 51b also causes the component length l to be varied (shortened). The volume of the outlet channel 107 correspondingly varies.

The rotation of the movable portions 51a, 51b causes the angle δ and also the width b_{EX} of the outlet opening 102 to change. In this way, the oscillation angle of the emerging fluid flow, the jet impetus and the pressure loss of the component can be varied. By means of a reduction of the width b_{EX} of the outlet opening 102, the jet impetus can be increased (in the case of an invariant internal pressure), and thus the cleaning performance can be increased as a result of the focusing of the jet force.

In a further embodiment, the axes of rotation Ra, Rb may be positioned even closer to the outlet opening 102, in order to thus minimize the coupling between the change in the angle δ and in the outlet width b_{EX}, or prevent a change in the outlet width b_{EX}.

In the embodiment from FIG. 6, the movable portions 51a, 51b of the delimiting wall 5, which delimit the outlet channel 107 perpendicular to the oscillation plane, are displaced linearly by means of a displacement device (not illustrated). Here, the movable portions 51a, 51b move in the oscillation plane respectively along an axis which lies in the plane that is defined by the respective movable portion 51a, 51b. In this way, the width b_{EX} of the outlet opening can be varied without varying the angle δ at the same time, which can lead to a change in the oscillation angle and in the jet impetus. The displacement device may have, for each movable portion 51a, 51b, a guide device in which the movable portion 51a, 51b is mounted. The guide devices enclose the angle δ (in the oscillation plane). Additionally, said angle between the guide devices may be variable. The movable portions 51a, 51b are displaceable between two maximum deflections, of which one is illustrated by a solid line and the other is illustrated by a dashed line. The maximum deflection positions are shown by way of example in FIG. 6.

By means of the displacement of the movable portions 51a, 51b, the spray characteristic, such as for example the oscillation angle, of the fluid flow can be changed. In this way, firstly, the spray angle α is varied. If the width b_{EX} of the outlet opening 102 is increased, the oscillation angle is also increased, and the spray impetus (in the case of an invariant throughflow) is reduced. This is advantageous for example for cleaning or wetting of (sensitive) surfaces.

Through variation of the width b_{EX} of the outlet opening 102, the nozzle size can be changed, that is to say, in the case of a constant entry pressure of the fluid, the throughflow can be regulated.

As an alternative to the movement of the movable portions 51a, 51b as per FIG. 6, it is possible, in the region of the outlet opening 102, for an aperture-like device to be provided which extends substantially perpendicular to the longitudinal axis A and by means of which the cross-sectional area of the outlet opening is variable without influencing the angle δ. In a further alternative, the movable portions 51a, 51b can be displaced in the oscillation plane transversely with respect to the longitudinal axis A in order to vary the cross-sectional area of the outlet opening without varying the angle δ.

The embodiment from FIG. 7 differs from that from FIG. 6 in particular in the direction along which the movable portions 51a, 51b are displaceable. In the embodiment from FIG. 7, the movable portions 51a, 51b are displaceable along the longitudinal axis A of the fluidic component. During such a displacement, the outlet width b_{EX} and the angle δ remain unchanged. Only the volume of the outlet channel 107 and the component length l of the fluidic component 1 change as a result of the displacement illustrated in FIG. 7. It can thus be achieved that the oscillation angle changes only to a small extent, whereas the oscillation frequency and the profile with respect to time of the emerging fluid flow change to a considerable extent.

FIG. 7 illustrates one of the maximum deflection positions by means of a solid line, the other by means of a dashed line. The positions are merely exemplary. Here, the two movable portions 51a, 51b can be moved independently of one another. In this way, the oscillation angle and the direction of the emerging fluid flow can be varied. If, for example, the movable portion 51a is moved downstream and the movable portion 51b is moved upstream, the direction of the emerging fluid flow changes in the direction of that movable portion 51b which is moved upstream.

Alternatively, the two movable portions 51a, 51b may also be moved simultaneously in the same way (direction, speed). This may be realized for example by means of a telescopic construction of the fluidic component 1. Here, it is for example the case that the movable portions 51a, 51b are displaced along the longitudinal axis A relative to the rest of the fluidic component 1 by means of rails.

Irrespective of the specific movement of the movable portions 51a, 51b (or of other movable elements), the material of the movable portions 51a, 51b (or of the other movable elements) may comprise a harder or more wear-resistant material than the rest of the delimiting wall 5. It would thus be possible for the fluidic component 1 to be manufactured from a rust-resistant steel, and for the movable portions 51a, 51b (or the other movable elements) to be manufactured from a ceramic material.

In FIGS. 8 to 10, the shape of the flow chamber 10 is realized not by means of a variation of the delimiting wall 5 but by means of a variation of the inner blocks 11a, 11b. Here, the two inner blocks 11a, 11b may basically be varied jointly or independently of one another. Furthermore, the two inner blocks may be varied in a similar or different manner.

In FIG. 8 and FIG. 9, the variation of the inner blocks 11a, 11b consists in a variation of the position of the inner blocks 11a, 11b by movement, in particular rotation, of the inner blocks 11a, 11b. The rotation may be performed by means of a device (not illustrated). Here, the rotation takes place about the axes of rotation Ra, Rb, which extend substantially perpendicular to the oscillation plane, between two maximum deflection positions. Here, one maximum deflection position is illustrated by way of example by a dashed line, whereas the other maximum deflection position is illustrated by way of example by a solid line. By means of the rotation of the inner blocks 11a, 11b, the volume of the main flow channel 103 and the angle γ between the inner blocks 11a, 11b can be varied. By means of this variation, the oscillation angle and the oscillation frequency, and the behavior with respect to time of the emerging fluid flow, can be varied. In FIG. 8, the axes of rotation Ra, Rb are situated each in a region of the inner blocks 11a, 11b facing toward the inlet opening 101 and the main flow channel 103. The axes of rotation Ra, Rb are arranged symmetrically with respect to the longitudinal axis A.

The embodiment from FIG. 9 differs from that from FIG. 8 with regard to the position of the axes of rotation Ra, Rb. Thus, the axes of rotation in FIG. 9 are arranged further upstream. As a result, in the embodiment from FIG. 9, the volume of the main flow channel 103 changes to a lesser extent than in FIG. 8 when the inner blocks 11a, 11b are rotated by the same angle.

Alternatively, the inner blocks 11a, 11b may not be rotated about an axis of rotation but rather displaced in the oscillation plane in order to change the shape of the flow chamber 10. By means of a displacement along the longitudinal axis A, the cross-sectional areas of the entrances 104a1, 104b1 and exits 104a2, 104b2 of the secondary flow channels can be varied. By means of a displacement transversely with respect to the longitudinal axis A, the width of the main flow channel 103 and of the secondary flow channels 104a, 104b (in the second portion) can be varied.

FIG. 10 illustrates two different embodiments for the variation of the inner blocks 11a, 11b. The inner block 11a illustrated on the left in FIG. 10 is varied by deformation, in particular by deformation of the inwardly pointing surface 110a of the inner block 11a. The inner surface 110a faces toward the main flow channel 103 and extends substantially perpendicular to the oscillation plane.

Here, the surface 110a to be deformed may for example comprise a spring material which can assume two stable or metastable states and can be moved back and forth between these two states by means of the action of an external force (imparted by a device) or by means of a so-called internal force. The so-called internal force may result from the pressure of the fluid flow flowing in the fluidic component.

In the case of the fluidic component being used in the field of agricultural technology, the material of the surface 110a that is to be deformed may be selected (with regard to material thickness and elasticity) such that it deforms if the pressure at the inlet opening changes by at least 0.01 bar. If the fluidic component is used in the cleaning sector, the material of the surface 110a that is to be deformed may be selected (with regard to material thickness and elasticity) such that it deforms if a pressure change, in the case of which it is the intention for the flow characteristic in the flow chamber 10 to change, of 5 bar (for low-pressure cleaning) or of 10 bar (for high-pressure cleaning) occurs at the inlet opening. These pressure specifications may also serve for the selection of a suitable material for the deformable portions, mentioned further above, of the parts 51a, 51b. Instead of the spring material, use may also be made of a so-called intelligent material, such as for example a shape memory alloy. The deformation of the inwardly pointing surface 110a of the inner block 11a may be predetermined by means of additional joints or pivot points 110a1 and fixed points 110a2. In a further alternative, the wall thickness of the inwardly pointing surface 110a of the inner block 11a may, in certain portions, be formed with varying thickness, such that the deformability (flexibility) of the material is varied in targeted fashion in certain portions, and the surface 110a can then be correspondingly deformed under the action of an external force. Preferably, the inwardly pointing surface 110a of the inner block 11a is, in one stable or metastable state, shaped such that the main flow channel 103 steadily widens or diverges in the downstream direction. In the other stable or metastable state, the inwardly pointing surface 110a of the inner block 11a is preferably shaped such that, in the downstream direction, the main flow channel 103 initially diverges (widens) and, at the level of the final third of the inner block 11a, converges (narrows) along the longitudinal axis A. (It is basically also possible for other shapes to be assumed in the stable or metastable states.) By means of the change, effected in this way, of the shape of the main flow channel 103, the change in acceleration of the fluid flow in the profile with respect to time is reduced, or the change in acceleration assumes an approximately sinusoidal course. It is particularly advantageous if the inwardly pointing surface 110a is formed by a planar surface or a curved surface with a large radius of curvature. The inwardly pointing surface 110a may also comprise polygons or splines in order to thus for the most part form a virtually constant angle γ between the inner blocks 11a, 11b. In this way, it is possible for wedges to be formed on the inwardly pointing surface 110a which project into the main flow channel 103.

In a further embodiment, the inner block 11a, 11b is constructed such that the fin-ray effect can be utilized. With this effect, by means of a displacement or an action of force at one point, a defined curvature of the inner delimiting wall 110a, 110b of the main flow channel 103 can be realized. By means of a skeleton-like construction of the inner block 11a, 11b which is suitable for the fin-ray effect, it is possible for the weight of the fluidic component to be reduced owing to the additional cavities within the inner block 11a, 11b. This fin-ray effect can also be used for the targeted variation of the size of the cross-sectional area of the outlet opening, for example through variation of the shape of the portions 51a, 51b.

The inner block 11b illustrated on the right in FIG. 10 is constructed from two parts 11b1, 11b2. The dividing line between the two parts 11b1, 11b2 extends substantially from the entrance 104b1 to the exit 104b2 of the secondary flow channel 104b. The two parts 11b1, 11b2 are movable (displaceable or rotatable) independently of one another in the oscillation plane. In FIG. 10, the two parts 11b1, 11b2 are, by way of example, displaceable. By means of the displacement of the part 11b1 (11b2) facing toward the main flow channel 103 (secondary flow channel 104b), the volume and the shape of the main flow channel 103 (secondary flow channel 104b) can be varied, while the geometry of the secondary flow channel 104b (main flow channel 103) remains substantially unchanged. During the movement of one part or of the two parts 11b1, 11b2 relative to one another, a channel 112b may form which extends substantially from the entrance 104b1 to the exit 104b2 of the secondary flow channel 104b. By means of the orientation of said channel 112b, a leakage flow between the main flow channel 103 and the secondary flow channel 104b can be prevented.

Through the variation of the shape of the inner blocks 11a, 11b as described with regard to FIG. 10, the oscillation angle and/or the profile with respect to time of the moving fluid jet can be adjusted. Although, in FIG. 10, the deformation of the inner block has been described only with regard to the left-hand inner block and the two-part design of the inner block has been described only with regard to the right-hand inner block, both embodiments may respectively be applied to both inner blocks.

In FIG. 11, the shape of the flow chamber 10 is varied through variation of the cross-sectional area of the secondary flow channels 104a, 104b. For this purpose, the delimiting wall 5 of the flow chamber 10 has, downstream of each entrance 104a1, 104b1 of the secondary flow channels 104a, 104b, one deformable portion 52a, 52b respectively. The deformable portions 52a, 52b are of symmetrical form with respect to the longitudinal axis A. However, it is also possible for only one such deformable portion, or two deformable portions which are asymmetrical with respect to the longitudinal axis A, to be provided. The local deformability of the material of the delimiting wall 5 in the portions 52a, 52b may be realized for example by means of a smaller material thickness (in relation to the rest of the delimiting wall 5) or by means of a different composition of the material. The user can deform the deformable portions 52a, 52b in targeted fashion by means of a device (not illustrated). Here, the deformed portions 52a, 52b project into the secondary flow channels 104a, 104b transversely with respect to the flow direction of the fluid flow in the secondary flow channels 104a, 104b. FIG. 11 illustrates, by way of example, only a deformed state of the deformable portions 52a, 52b, not the non-deformed state of the deformable portions 52a, 52b. Alternatively, the deformable portions 52a, 52b may also be provided at another position, for example closer to the exits 104a2, 104b2 of the secondary flow channels 104a, 104b.

As an alternative to the deformable portions, the cross-sectional area of the secondary flow channels 104a, 104b may also be varied by means of a slide which can be moved into the secondary flow channels 104a, 104b transversely with respect to the flow direction in the secondary flow channels 104a, 104b.

In this embodiment, in the case of compressible fluids, it is substantially possible for the oscillation frequency to be varied. (In the case of an excessive reduction of the cross-sectional area of the secondary flow channels 104a, 104b, the oscillation may however be rendered inactive.) In this way, a fan jet can be generated which extends orthogonally with respect to the original oscillation plane.

FIG. 12 illustrates a fluidic component 1 in which the width b_{IN} of the inlet opening 101 is variable. For this purpose, the wall that forms the funnel-shaped extension 106 is of multi-part form. The funnel-shaped extension is arranged upstream of the inlet opening 101. The wall of the funnel-shaped extension 106 accordingly has two portions 1061a, 1061b which extend substantially transversely with respect to the oscillation plane. The position of the two portions 1061a, 1061b is displaceable in the oscillation plane and transversely with respect to the longitudinal axis A. In this way, the width of the funnel-shaped extension 106 and thus of the inlet opening 101 can be varied. Depending on the shape of the inner blocks 11a, 11b, shape of the separators 105a, 105b (if present) and characteristics of the fluid (type of the fluid, entry pressure and volume flow), it is possible, through variation of the width b_{IN} of the inlet opening 101, for the spray characteristic of the emerging fluid flow to be adjusted between a virtually punctiform jet and an oscillating fan jet. In this way, it is for example possible to set the output per unit of area of the fluidic component in accordance with the field of use.

In FIG. 13, for the change in the shape of the flow chamber 10, the component length l of the fluidic component 1 is designed to be variable. For this purpose, the delimiting wall 5 is of telescopic or bellows-like form. This requires an at least two-part construction of the delimiting wall 5, wherein one of the two parts can be pushed into the other of the two parts and pulled out of the latter along the longitudinal axis A. In FIG. 13, the fluidic component 1 is illustrated by way of example in two different states, which each have different component lengths l, l′. Here, that part of the delimiting wall 5 which is displaceable relative to the other part is illustrated by means of dashed lines in one case and by means of a solid line in the other case.

Aside from the delimiting wall 5, the inner blocks 11a, 11b are also of telescopic or bellows-like design in order to adapt the length l₁₁, l₁₁′ of the inner blocks 11a, 11b in accordance with the component length l, l′ of the fluidic component 1. The change in the length l of the fluidic component 1 and in the length of the inner blocks 11a, 11b may be realized here in a mutually independent or coupled manner. In a further embodiment, it is possible for either only the length l₁₁, l₁₁′ of the inner blocks 11a, 11b or the component length l, l′ of the fluidic component 1 to be varied.

By means of the embodiment illustrated in FIG. 13, it is possible for the jet profile with respect to time of the emerging fluid jet and the oscillation angle to be varied. With increasing component length l, the jet profile with respect to time approximates to a rectangular function. If the component length is lengthened further once the rectangular function has been attained, then the oscillation angle decreases until, finally, a quasistatic orifice jet is realized.

In a further embodiment, in the event of a change in the length of the inner blocks 11a, 11b, the orientation of the inwardly pointing surfaces 110a, 110b of the inner blocks 11a, 11b can also change, such that the angle γ simultaneously jointly changes. The change in the oscillation angle can thus be amplified. This is the case for example if the length l₁₁ of the inner blocks 11a, 11b is changed but the distance between the inner blocks 11a, 11b (in the oscillation plane and transversely with respect to the longitudinal axis A) remains unchanged.

FIG. 14 shows an embodiment which is similar in principle to FIG. 13. However, in FIG. 14, the component depth t is variable. In this way, the cross-sectional area (transversely with respect to the longitudinal axis A) of the main flow channel 103 and of the secondary flow channels 104a, 104b can be varied. For this purpose, the delimiting wall 5 and the inner blocks 11a, 11b are of telescopic or plunger-like form and can be adjusted by means of a device (not illustrated). By means of the embodiment from FIG. 14, the oscillation angle can be varied. The oscillation angle is decreased in the case of a reduction of the component depth t.

FIG. 15 shows a fluidic component 1 with two inner blocks 11a, 11b, which have each one channel 113a, 113b which extends through the inner blocks 11a, 11b. Here, each channel 113a, 113b is oriented such that it fluidically connects the main flow channel 103 to the secondary flow channel 104a, 104b that is separated by the respective inner block 11a, 11b from the main flow channel 103. The orientation of the channels 113a, 113b is illustrated in FIG. 15 by way of example and as being different for the two inner blocks 11a, 11b. Alternatively, the two channels 113a, 113b may be oriented symmetrically (with respect to the longitudinal axis A). The channels 113a, 113b may also assume other positions within the inner blocks 11a, 11b than those illustrated in FIG. 15. It is also possible for multiple channels to be formed within an inner block. The channels 113a, 113b are designed to be closable, such that a fluidic connection between the main flow channel 103 and the secondary flow channels 104a, 104b can be produced selectively by means of the channels 113a, 113b. The secondary flow channels 104a, 104b may additionally be designed to be closable. Thus, the main flow channel 103 can be fluidically connected to the corresponding secondary flow channel 104a, 104b selectively via the channel 113a, 113b or via the entrance 104a1, 104b1 and the exit 104a2, 104b2 of the secondary flow channels 104a, 104b.

Depending on the arrangement of the channels 113a, 113b, the oscillation frequency of the fluid flow and the jet profile with respect to time of the emerging fluid jet can be changed.

The embodiment from FIG. 16 provides a change in the shape of the flow chamber 10 by means of a deformation of the inner blocks 11a, 11b. Here, the inner blocks 11a, 11b have each two deformable regions 152a, 153a, 153a, 153b. These each face toward the main flow channel 103 and are formed in the inwardly pointing surfaces 110a, 110b of the inner blocks 11a, 11b. Each of the deformable regions can assume two shapes. Each shape may in this case correspond to a (meta)stable state of the material, such that, in the event of a change in shape, the material switches back and forth between the (meta)stable states. The two deformable regions of an inner block are arranged one behind the other in a downstream direction. The two deformable regions 152a, 153a of one inner block 11a are identical (with regard to shape, deformation and position) to the deformable regions 152b, 153b of the other inner block 11b. FIG. 16 illustrates, for each deformable region 152a, 152b, 153a, 153b, respectively both of the shapes that said regions can assume. For the sake of clarity, for each deformable region, one of the two shapes is illustrated by dashed lines, and the other of the two shapes is illustrated by a solid line. The deformable regions 152a, 152b, 153a, 153b may be deformed individually, wherein, preferably, a deformable region of one inner block and the corresponding deformable region of the other inner block are shaped similarly, such that a total of four combinations are possible. The regions 152a, 152b, 153a, 153b are deformable by means of a device which is actuatable by the user. The deformation causes the shape of the main flow channel 103 to change, which leads to a change in the oscillation angle of the emerging fluid flow. Alternatively, the regions 152a, 153a, 152b, 153b may, by means of a plunger-like movement of a device (not illustrated), be moved into the main flow channel 103 or out of the latter in the oscillation plane.

Downstream of the outlet opening 102, there may additionally be provided an outlet widening 108. This is illustrated by way of example in the embodiments from FIGS. 1 and 17. Preferably, the outlet widening 108 has a length l₁₀₈ (extent along the longitudinal axis A) which amounts to at least 25% of the outlet width b_{EX}. Thus, the spray jet is guided within the oscillation plane and thus leads to an increase in the jet impetus. The additional outlet widening 108 is advantageous in particular for cleaning applications. The outlet widening comprises two portions 53a, 53b of the delimiting wall which extend substantially perpendicular to the oscillation plane. Said two portions 53a, 53b may be movable, in particular rotatable about an axis which extends substantially perpendicular to the oscillation plane. In the embodiment from FIG. 17, the two portions 53a, 53b are rotatable about the axes of rotation Ra, Rb. The axes of rotation Ra, Rb are arranged at the transition between the outlet channel 107 and the outlet widening 108, that is to say (as viewed along the longitudinal axis A) at the level of the outlet opening 102. These may also be arranged differently, similarly to the position illustrated by way of example in FIG. 4 or FIG. 5. In FIG. 17, the axes of rotation Ra, Rb are arranged slightly outside the outlet opening 102. Alternatively, the axes of rotation Ra, Rb may be arranged exactly at the upstream end of the two portions 53a, 53b. By means of a rotation of the two portions 53a, 53b about the axes of rotation Ra, Rb, the angle ε between the two portions 53a, 53b of the outlet widening can be varied. The rotation may be driven by a device (not illustrated). A further variant for the adjustment of the angle ε is for the axes of rotation Ra, Rb to be situated in the vicinity of the outlet opening 102, that is to say shifted upstream or downstream in relation to the outlet opening 102 along the longitudinal axis A.

In the embodiment of FIG. 18, the shape of the outlet opening 102 is variable. In particular, the outlet opening 102 has a radius 109, 109′, 109″, the magnitude of which is variable. In the event of variation of the radius 109, 109′, 109″, a variation of the shape of the adjoining portions of the delimiting walls of the outlet channel 107 and of the outlet widening 108, and possibly of the angle c, may also occur. In FIG. 18, the outlet opening 102 is illustrated with a sharp edge as a solid line. Here, the radius 109 is equal to zero. Alternative shapes of the outlet opening 102 are illustrated using dashed lines. Here, the outlet opening (as viewed in the oscillation plane) has the radius 109′ on the left-hand side and the radius 109″ on the right-hand side, which radii are of different magnitude and are each greater than zero degrees. Alternatively, the radii on the left-hand side and on the right-hand side may be equal. For the change of the radius of the outlet opening 102, a body 190 is provided which is displaceable in the oscillation plane and which, by displacement, can exert a force on the elastically deformable material that delimits the outlet opening 102 and the adjacent regions of the outlet channel 107 and of the outlet widening 108, and which can thus effect a deformation of the elastic material. The displacement of the body 190 is indicated in FIG. 18 by a double arrow.

FIG. 19 shows a further embodiment, in which four secondary flow channels 104a, 104a′, 104b, 104b′ are formed. Here, respectively two secondary flow channels 104a, 104a′ and 104b, 104b′ form a unit in which the two secondary flow channels are connected in parallel. This is understood to mean that, at a given point in time, always only one secondary flow channel of the unit can be flowed through by the fluid flow. The other secondary flow channel of the unit is, at this point in time, closed by means of a partition 181a, 181a′, 181b, 181b′. The partitions 181a, 181a′, 181b, 181b′ are movable into and out of the secondary flow channels by means of a device (not illustrated). Here, the partitions of a unit may be coupled such that a movement of one partition 181a, 181b into the corresponding secondary flow channel 104a, 104b is linked to a movement of the other partition 181a′, 181b′ out of the corresponding other secondary flow channel 104a′, 104b′. The fluid flows only through the secondary flow channel that is not closed by a partition. The two secondary flow channels 104a, 104a′ and 104b, 104b′ respectively of a unit have a different shape. By actuation of the device, it is thus possible for that secondary flow channel which has the shape required for generating the desired jet profile of the fluid flow at the outlet opening to be opened up and flowed through. In the embodiment of FIG. 19, the units are identical and are each oriented mirror-symmetrically with respect to the main flow channel 103. Here, each unit has a relatively short secondary flow channel 104a, 104b and a relatively long secondary flow channel 104a′, 104b′. While the relatively short secondary flow channel 104a, 104b runs predominantly rectilinearly, the relatively long secondary flow channel 104a′, 104b′ is a series, meandering arrangement of three predominantly rectilinear portions running parallel to one another. The number of portions may also deviate from three.

In the embodiment of FIG. 20, elements 200, 200′, 200″ around which flow can pass are provided, which project into the flow chamber 10 transversely with respect to the oscillation plane in the region of the entrance 104a1, 104b1 and of the exit 104b2 of the secondary flow channels 104a, 104b. The arrangement in the region of the entrances 104a1, 104b1 and of the exit 104b2 is merely an example, such that any desired combination of the entrances 104a1, 104b1 and of the exits 104a2, 104b2 is conceivable.

FIG. 20 illustrates various embodiments (shape, relative arrangement) of the elements 200, 200′, 200″ around which flow can pass, wherein these embodiments are also to be understood merely as examples. Illustrated in the region of the entrance 104a1 of the secondary flow channel 104a is an element 200 around which flow can pass, which has an elliptical cross section in the oscillation plane and which is rotatable about an axis extending substantially perpendicular to the oscillation plane. The rotatability is indicated by the curved double arrow. The axis of rotation is situated in this case in the center of the element 200, though may also lie eccentrically. Aside from the elliptical shape, use may also be made of other shapes, preferably (elongate) shapes which, when rotated, give rise to a considerable change in the shape of the entrance 104a1 of the secondary flow channel 104a.

Illustrated in the region of the entrance 104b1 of the secondary flow channel 104b are multiple (in this case, by way of example, three) elements 200′ around which flow can pass, which in the oscillation plane have an (in this case exemplary) circular cross section and which are displaceable in the oscillation plane. A device provided for the displacement of the elements 200′ is not illustrated in FIG. 20. The displaceability is indicated by double arrows.

Illustrated in the region of the exit 104b2 of the secondary flow channel 104b is a translationally adjustable element 200″ which is of (in this case exemplary) sickle-shaped form in the oscillation plane. The element 200″ is fastened to a device 201 which serves for changing the position and/or the orientation of the element 200″. By means of the position of the adjustable element 200″, the flow in the main flow channel can be additionally influenced, and the spray characteristic of the emerging fluid flow thus set in targeted fashion. Here, the further the element 200″ projects into the main flow channel 103, the smaller the oscillation angle of the emerging fluid flow can become.

The elements 200, 200′, 200″ illustrated in FIG. 20 may be movable between two positions or multiple positions (for example intermediate positions between the two positions) or else in continuously variable fashion. The extent of the movement is in this case restricted to the elements 200, 200′, 200″ remaining in the respective entrance or exit region 104a1, 104b1, 104a2, 104b2 and in particular not passing into the outlet channel 107 or main flow channel 103.

FIGS. 21 and 22 illustrate a further embodiment. Here, FIG. 22 illustrates a sectional illustration through the fluidic component from FIG. 21 transversely with respect to the oscillation plane along the line A′-A″. In this embodiment, the fluidic component has two secondary flow channels 104a, 104b, which have each one opening 170a, 170b. The openings 170a, 170b are in this case, by way of example, arranged approximately centrally between the entrance 104a1, 104b1 and the exit 104a2, 104b2 of each secondary flow channel 104a, 104b. However, the openings 170a, 170b may also be arranged at other positions between the entrance 104a1, 104b1 and the exit 104a2, 104b2 of the secondary flow channels 104a, 104b. In the embodiment of FIGS. 21 and 22, the two openings 170a, 170b are situated substantially at the same height as viewed in the fluid flow direction (or along the line A′-A″). For example, the openings 170a, 170b are each formed in the front wall 12 of the fluidic component. A closable connecting channel 170 opens into the two openings 170a, 170b. The openings 170a, 170b and the connecting channel 170 have a rectangular cross section in the embodiment of FIGS. 21 and 22. Other cross-sectional shapes are however likewise possible. The connecting channel 170 is closable by means of a partition 171 which is movable (transversely with respect to the fluid flow direction) into the connecting channel 170 and out of the latter again (by means of rotation or translation). The partition 171 may be arranged at any desired point between the openings 170a, 170b. Alternatively, in the region of each opening 170a, 170b, there may be provided respectively one partition 171 which separate the secondary flow channels 104a, 104b from the connecting channel 170 already in the region of the openings 170a, 170b. The position of the partition 170 is variable by means of a mechanism which is not illustrated. In FIG. 22, the component depth t of the fluidic component is illustrated, by way of example, as being constant. Alternatively, the component depth t may be non-constant.

In all embodiments in which a rotation about an axis of rotation is provided, it is possible for an eccentric to be used instead of the axis of rotation. It is thus possible for the relationship between an angle variation (for example of the angle δ or of the angle γ) and a change in distance (for example of the outlet width b_{EX} or between those ends of the inner blocks 11a, 11b which face toward the inlet opening) to be reduced, or for the angle to be changed without simultaneously changing the distance.

In all embodiments in which multiple parts can be moved, the movement of said parts may take place in a coupled manner or independently of one another and simultaneously or in a time-offset manner. The speed with which the movement takes place may also be configured to be equal or different for the multiple parts.

1. A fluidic component having a flow chamber, which flow chamber can be flowed through by a fluid flow which enters the flow chamber through an inlet opening of the flow chamber and which exits the flow chamber through an outlet opening of the flow chamber, wherein, in the flow chamber, there is provided at least one deflection device for generating an oscillation of the fluid flow at the outlet opening,
wherein the flow chamber if has a variable shape.

2. The fluidic component as claimed in claim 1, wherein the flow chamber is delimited by a delimiting wall.

3. The fluidic component as claimed in claim 1, wherein the flow chamber has a main flow channel, which connects the inlet opening and the outlet opening to one another, and at least one secondary flow channel, as a deflection device for generating an oscillation of the fluid flow at the outlet opening, wherein the main flow channel and the at least one secondary flow channel are separated from one another by at least one inner block.

4. The fluidic component as claimed in claim 2, wherein the delimiting wall has at least one portion which is deformable.

5. The fluidic component as claimed in claim 3, wherein the flow chamber is delimited by a delimiting wall and the delimiting wall has at least one portion, which is deformable, of the delimiting wall forms a portion of the at least one secondary flow channel.

6. The fluidic component as claimed in claim 3, wherein the flow chamber is delimited by a delimiting wall and the delimiting wall has at least one portion which is deformable, and wherein the at least one portion which is deformable, and where in the at least one portion, which is deformable, of the delimiting wall delimits the outlet opening.

7. The fluidic component as claimed in claim 2, wherein the delimiting wall comprises at least two parts, and wherein one of the two parts is movable, in particular displaceable or rotatable, relative to the other of the two parts.

8. The fluidic component as claimed in claim 3, wherein the flow chamber is delimited by a delimiting wall, wherein the delimiting wall comprises at least two parts, wherein one of the two parts is movable, in particular displaceable or rotatable, relative to the other two parts, wherein the flow chamber has, upstream of the outlet opening, an outlet channel which opens at its downstream end into the outlet opening, and wherein a portion of the outlet channel is formed by two parts of the delimiting wall which are movable, in particular displaceable or rotatable, relative to a third part of the delimiting wall.

9. The fluidic component as claimed in claim 8, wherein the oscillation of the fluid flow is generated in an oscillation plane, wherein the two parts of the delimiting wall which form a portion of the outlet channel extend substantially perpendicular to the oscillation plane and enclose an angle in the oscillation plane.

10. The fluidic component as claimed in claim 9, wherein at least one of the two parts of the delimiting wall which form a portion of the outlet channel are rotatable, with a change of the angle, relative to the third part of the delimiting wall, and the two parts of the delimiting wall which for a portion of the outlet channel are displaceable, with a change of the width of the outlet opening, relative to the third part of the delimiting wall.

11. (canceled)

12. The fluidic component as claimed in claim 7, wherein the flow chamber is delimited by a delimiting wall, wherein the delimiting wall comprises at least two parts, wherein one of the two parts is moveable, in particular displaceable or rotatable, relative to the other of the two parts, and wherein at least of the two parts of the delimiting wall which form a portion of the outlet channel has at least one deformable portion.

13. The fluidic component as claimed in claim 2, wherein the flow chamber has a main flow channel, which connects the inlet opening and the outlet opening to one another, and at least one secondary flow channel, as a deflection device for generating an oscillation of the fluid flow at the outlet opening, wherein the main flow channel and the at least one secondary flow channel are separated from one another by at least one inner block, and wherein at least one
the at least one inner block is deformable and/or is movable relative to the delimiting wall, and
the at least one inner block is of two-part form, wherein one part of the inner block is movable relative to the other part of the inner block, or the two parts of the inner block are movable independently of one another relative to the delimiting wall.

14. The fluidic component as claimed in claim 1, wherein the fluidic component has a component length, a component width and a component depth, wherein the component length is defined along a direction which extends substantially from the inlet opening to the outlet opening, and the component width and the component depth are each defined perpendicularly with respect to one another and with respect to the component length, wherein the extent of the flow chamber along the component length, the component depth or the component width is variable.

15-17. (canceled)

18. The fluidic component as claimed in claim 1, wherein the outlet opening is adjoined, downstream, by an outlet widening, wherein the outlet widening encloses and angle in the oscillation plane, and wherein the angle of the outlet widening is variable.

19. (canceled)

20. The fluidic component as claimed in claim 1, wherein at least one of the outlet opening has, in the oscillation plane, a radius, the magnitude of which is variable, wherein, in the event of a change in the radius, it is in particular the case that the shape of an outlet channel which adjoins the outlet opening upstream, and/or the shape of an outlet widening which adjoins the outlet opening downstream, also change(s), and the inlet opening has a variable width, wherein the width of the inlet opening is directed substantially perpendicular to a direction extending from the inlet opening to the outlet opening, and lies in the oscillation plane.

21. (canceled)

22. The fluidic component as claimed in claim 3, wherein at least one of the flow chamber has at least two secondary flow channels connected in parallel as deflection device for generating an oscillation of the fluid flow at the outlet opening, wherein the at least two secondary flow channels have a different shape, and wherein, at a given point in time, only one of the at least two secondary flow channels connected in parallel can be flowed through by the fluid flow, or the at least two secondary flow channels connected in parallel has/have each one entrance and each one exit and extends/extend between the respective entrance and the respective exit, and in that, in the region of at least one entrance and/or of at least one exit, one or multiple elements projects/project into the flow chamber such it/they can be flowed around by the fluid flow, wherein the one or multiple elements is/are adjustable in position within the region of the at least one entrance and/or of the at least one exit, and at least two secondary flow channels are provided, which are connectable to one another via a closable connecting channel.

23-24. (canceled)

25. The fluidic component as claimed in claim 1, wherein the fluidic component comprises a device for varying the shape of the flow chamber in targeted fashion.

26. A fluidic assembly having a fluidic component as claimed in claim 1, wherein the fluidic component is embedded into a sealing body which seals off the entire fluidic component with the exception of the inlet opening and the outlet opening of the fluidic component.

27. A fluid-distributing appliance, in particular for cleaning and/or watering purposes, having a device for generating a fluid jet,
wherein the device comprises a fluidic component as claimed in claim 1.

28. The fluidic component as claimed in claim 3, wherein the at least one inner block has a channel which extends through the at least one inner block such that the channel fluidically connects the main flow channel and the at least one secondary flow channel to one another.
